(19) United States
(12) Patent Application Publication
(10) Pub. No.: US 2019/0376648 A1
(43) Pub. Date: Dec. 12, 2019

(54) SYSTEM AND METHOD FOR BALANCED REFUELLING OF A PLURALITY OF COMPRESSED GAS PRESSURE VESSELS

(71) Applicant: MOSAIC TECHNOLOGY DEVELOPMENT PTY LTD, Crestmead (AU)

(72) Inventors: Paul Anthony WHITEMAN, Crestmead (AU); Derek Shane FEKETE, Crestmead (AU)

(73) Assignee: MOSAIC TECHNOLOGY DEVELOPMENT PTY LTD, Crestmead (AU)

(21) Appl. No.: 16/550,079

(22) Filed: Aug. 23, 2019

Related U.S. Application Data
(63) Continuation of application No. 14/911,015, filed on Feb. 8, 2016, now abandoned.

(30) Foreign Application Priority Data
Aug. 9, 2013 (AU) 2013902992

(51) Int. Cl. F17C 7/00

(52) U.S. Cl. CPC F17C 7/00

(57) ABSTRACT

A pressure vessel balanced refuelling system enables greater volumes of gas to be used as working volumes and increases gas storage efficiency. The system includes a plurality of pressure vessels, each vessel having a liquid transfer opening for the entry and exit of a liquid that is used to displace a gas inside each vessel. A liquid transfer line extends from an outside to an inside of each vessel in the plurality of pressure vessels through the liquid transfer opening, and a liquid balance line inter-connects the liquid transfer opening of each vessel with the liquid transfer opening of each other vessel. Thus a balance liquid transfer path extends from an inside to an outside of one vessel, then from the outside to the inside of each other vessel through the liquid balance line, enabling a liquid level in the one vessel to remain approximately equal to a liquid level in each other vessel.

### FIELD OF THE INVENTION

This invention relates generally to a compressed gas transfer system for gas storage and delivery. In particular, the invention relates to a Compressed Natural Gas (CNG) transfer system including a method for refuelling a plurality of CNG cylinders that maintains balanced pressures, liquid volumes and gas volumes across the plurality of cylinders.

### BACKGROUND OF THE INVENTION

Natural gas fuels are relatively environmentally friendly for use in vehicles, and hence there is support by environmental groups and governments for the use of natural gas fuels in vehicle applications. Natural gas based fuels are commonly found in three forms: Compressed Natural Gas (CNG), Liquefied Natural Gas (LNG) and a derivative of natural gas called Liquefied Petroleum Gas (LPG).

Natural gas fuelled vehicles have impressive environmental credentials as they generally emit very low levels of SO₂ (sulphur dioxide), soot and other particulate matter. Compared to gasoline and diesel powered vehicles, CO₂ (carbon dioxide) emissions of natural gas fuelled vehicles are often low due to a more favourable carbon-hydrogen ratio found in natural gas. Natural gas vehicles come in a variety of forms, from small cars to (more commonly) small trucks and buses. Natural gas fuels also provide engines with a longer service life and lower maintenance costs. Further, CNG is the least expensive alternative fuel when comparing equal amounts of fuel energy. Still further, natural gas fuels can be combined with other fuels, such as diesel, to provide benefits similar to the benefits mentioned above.

A key factor limiting the use of natural gas in vehicles is the storage of the natural gas fuel. In the case of CNG and LNG, the fuel tanks are generally expensive, large and cumbersome relative to tanks required for conventional liquid fuels having equivalent energy content. In addition, the relative lack of wide availability of CNG and LNG refuelling facilities, and the cost of LNG, add further limitations on the use of natural gas as a motor vehicle fuel. Further, in the case of LNG, the cost and complexity of producing LNG and issues associated with storing a cryogenic liquid on a vehicle further limits the widespread adoption of this fuel.

Some of the above issues are mitigated when using LPG and this fuel is widely used in high mileage motor cars such as taxis. However, cost versus benefit comparisons are often not favourable in the case of private motor cars. Issues associated with the size and shape of the fuel tank, the cost variability of LPG and the sometimes limited supply mean that LPG also has significant disadvantages that limit its widespread adoption. In summary, unless there is massive investment in a network of LNG plants around major transport hubs, CNG is the only feasible form of natural gas that is likely to be widely utilised in the near future.

However, some well known technical challenges need to be overcome to better exploit the advantages of CNG fuel. For example, the pressure to which composite CNG cylinders can be filled is limited due to the heat of compression overheating the cylinder being filled. This has typically meant that 248 BAR at 21 deg C. (settled temperature) is the limit for composite CNG cylinder filling, and has become the standard adopted in many parts of the world including the US.

In the US, codes typically allow for filling to an overpressure of 1.25 times the pressure rating of the CNG cylinder provided it would subsequently settle to 248 BAR if cooled to 21 deg. C. The code also identifies in cylinder heating as having the potential to cause transient temperature excursions exceeding cylinder design parameters.

In Europe the relevant codes limit the maximum pressure in composite CNG cylinders during re-fuelling to 260 barg to ensure maximum design temperatures are not exceeded.

These limitations have meant that the currently available composite cylinders designed for 350 barg operating pressure and above cannot be utilised in conventional CNG re-fuelling systems. This means that the opportunity to utilise smaller CNG cylinders or to achieve increases in range for the same size cylinders, cannot be realised. International Patent Application Publication No. WO 2008/074075, titled “A Compressed Gas Transfer System”, disclosed for the first time a liquid delivery system that enables the volume in a pressure vessel to be varied to maintain gas in the pressure vessel at a near constant pressure. That enables a CNG tank to be maintained at a consistent high pressure (e.g., greater than 3000 psig) while the tank is emptied to supply fuel to a high pressure direct injection engine. In addition it disclosed a method of fuel transfer onto the vehicle that held the vehicle tank at a relatively constant high pressure, enabling the fuel to transfer at high pressure, and eliminating the heat of compression in the CNG cylinder.

Further, International Patent Application Publication No. WO 2013/056295, titled “System and Method for Refuelling of Compressed Gas Pressure Vessels”, disclosed further improvements in constant pressure refuelling of on-vehicle CNG storage tanks. This publication disclosed a refuelling process that can be performed via a conventional single CNG refuelling connection, with the liquid contained in a plurality of on-vehicle pressure vessels providing the necessary fluid inventory to control the filling process and for the filling process to commence immediately upon connection to a CNG refuelling source.

However, when re-fuelling multiple CNG cylinders of an inter-connected CNG storage and delivery system, such as a roadside storage system, it can be difficult to accurately measure the actual volume of gas present in the plurality of cylinders. In particular, when gas is delivered to a multiple cylinder storage system through a single supply line, the prior art systems can result in unbalanced pressures, liquid levels and gas volumes across the plurality of cylinders. Such imbalances can render the system unworkable or require the application of relatively large safety factors when estimating maximum fill levels, which in turn can reduce the useable, total working volume of the cylinders.

Therefore, there is a need for an improved method and system of balanced refuelling of a plurality of compressed gas pressure vessels.

### OBJECT OF THE INVENTION

It is an object of some embodiments of the present invention to provide consumers with improvements and advantages over the above described prior art, and/or overcome and alleviate one or more of the above described disadvantages of the prior art, and/or provide a useful commercial choice.

### SUMMARY OF THE INVENTION

In one form, although not necessarily the only or broadest form, the invention resides in a pressure vessel balanced refuelling system, comprising:

a plurality of pressure vessels, each vessel having a liquid transfer opening for the entry and exit of a liquid that is used to displace a gas inside each vessel;

a liquid transfer line extending from an outside to an inside of each vessel in the plurality of pressure vessels through the liquid transfer opening; and

a liquid balance line inter-connecting the liquid transfer opening of each vessel with the liquid transfer opening of each other vessel;

whereby a balance liquid transfer path extends from an inside to an outside of one vessel, then from the outside to the inside of each other vessel through the liquid balance line, enabling a liquid level in the one vessel to remain approximately equal to a liquid level in each other vessel.

Suitably, each vessel contains a liquid diffuser at a distal end of the liquid transfer line.

Suitably, the liquid diffuser comprises a high surface area matrix construction.

Suitably, the liquid diffuser comprises a mesh.

Suitably, the liquid transfer line extends through the liquid transfer opening of each vessel in a “pipe in pipe” arrangement.

Suitably, each vessel further comprises an oil layer that separates the liquid from the gas.

Suitably, the liquid transfer line branches from a main line to a plurality of vessel-specific liquid lines, wherein one vessel-specific liquid line extends into each vessel in the plurality of vessels.

Suitably, during a liquid transfer process, a liquid flow rate through each vessel-specific liquid line is different than a liquid flow rate through each other vessel-specific liquid line.

Suitably, during a liquid transfer process, the liquid flows through the liquid balance line to eliminate liquid level imbalances between the plurality of pressure vessels.

Suitably, the system further comprises:

each vessel having a gas transfer opening for the entry and exit of a gas;

a gas transfer line extending from an outside to an inside of each vessel in the plurality of pressure vessels through the gas transfer opening; and

a gas balance line extending from an outside to an inside of each vessel in the plurality of pressure vessels and inter-connecting the gas transfer opening of each vessel with the gas transfer opening of each other vessel;

whereby a balance gas transfer path extends from an inside to an outside of one vessel, then from the outside to the inside of each other vessel through the gas balance line, enabling a gas pressure in the one vessel to remain equal to a gas pressure in each other vessel.

Suitably, the gas transfer line extends through the gas transfer opening of each vessel in a “pipe in pipe” arrangement.

Suitably, the gas transfer line branches from a main line to a plurality of vessel-specific gas lines, wherein one vessel-specific gas line extends into each vessel in the plurality of vessels.

Suitably, during a gas transfer process, a gas flow rate through each vessel-specific gas line is approximately equal to a gas flow rate through each other vessel-specific gas line.

Suitably, during a gas transfer process, the gas flows through the gas balance line to eliminate pressure imbalances between the plurality of pressure vessels.

Suitably, the refuelling system is a stationary system for CNG storage and delivery.

Suitably, the refuelling system is a mobile system for CNG storage and delivery.

Suitably, a pressure measurement instrument is attached to the liquid balance line.

Suitably, a pressure measurement instrument is attached to the gas balance line.

### BRIEF DESCRIPTION OF THE DRAWINGS

An embodiment of the invention is described with reference to the accompany drawings in which:

FIG. 1 is a diagram illustrating a cutaway and sectional view of a pressure vessel balanced refuelling system for CNG storage and delivery, according to an embodiment of the present invention.

FIG. 2 is a diagram illustrating a close up view of the liquid plumbing at the bottom portion of one of the CNG pressure vessels shown in FIG. 1.

FIG. 3 is a diagram illustrating a close up view of the gas plumbing at the top portion of the CNG pressure vessel shown in FIG. 2.

### DETAILED DESCRIPTION OF THE PREFERRED EMBODIMENT

Elements of the invention are illustrated in concise outline form in the drawings, showing only those specific details that are necessary to understanding the embodiments of the present invention, but so as not to clutter the disclosure with excessive detail that will be obvious to those of ordinary skill in the art in light of the present description.

In this patent specification, adjectives such as first and second, left and right, front and back, top and bottom, etc., are used solely to define one element from another element without necessarily requiring a specific relative position or sequence that is described by the adjectives. Words such as “comprises” or “includes” are not used to define an exclusive set of elements or method steps. Rather, such words merely define a minimum set of elements or method steps included in a particular embodiment of the present invention. It will be appreciated that the invention may be implemented in a variety of ways, and that this description is given by way of example only. Further, CNG cylinders are synonymously referred to as tanks, vessels, pressure vessels, and cylinders.

In one form, the invention resides in a pressure vessel balanced refuelling system, comprising:

a plurality of pressure vessels, each vessel having a liquid transfer opening for the entry and exit of a liquid that is used to displace a gas inside the vessel;

a liquid transfer line extending from an outside to an inside of each vessel in the plurality of pressure vessels through the liquid transfer opening; and

a liquid balance line inter-connecting the liquid transfer opening of each vessel with the liquid transfer opening of each other vessel;

whereby a balance liquid transfer path extends from an inside to an outside of one vessel, then from the outside to the inside of each other vessel through the liquid balance line, enabling a liquid level in the one vessel to remain approximately equal to a liquid level in each other vessel.

Various embodiments of the present invention include numerous advantages. For example, embodiments of the invention enable accurate, real time measurement of liquid levels inside a plurality of CNG vessels at high pressure as liquid is pumped into or out of the vessels. A static liquid header enables relatively small amounts of liquid to flow between vessels, which balances any differences in liquid levels across the plurality of vessels caused by, for example, pump pressure pulses and unequal flow losses.

Further, according to some embodiments, a static gas header enables relatively small amounts of gas to flow between vessels, further allowing gas pressures and liquid levels inside the vessels to equalise. Because gas pressures and liquid levels are balanced and equal across a plurality of vessels in a system, significantly greater volumes (for example, greater than 90%) of the volumes of the vessels can be used as working volumes. That enhances the overall efficiency and effectiveness of the system.

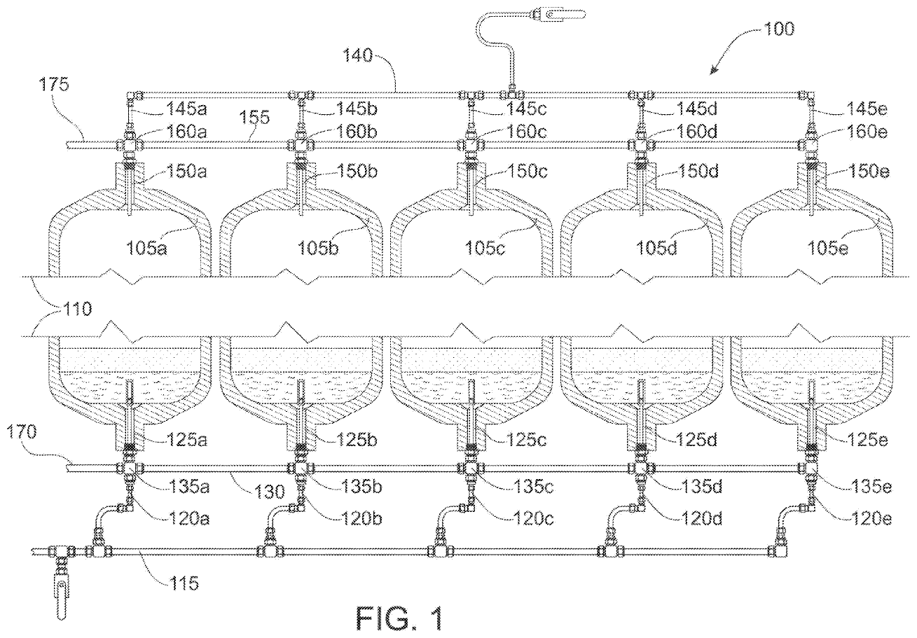

FIG. 1 is a diagram illustrating a cutaway and sectional view of a pressure vessel balanced refuelling system 100 for CNG storage and delivery, according to an embodiment of the present invention. The system 100 provides constant pressure CNG fuel storage and delivery, eliminating the issue of in cylinder recompression heating during refuelling, and enabling reliable filling to a pressure vessel's design capacity.

The system 100 includes five compressed natural gas (CNG) pressure vessels 105a, 105b, 105c, 105d, 105e that together define a total CNG storage volume. Each vessel 105a-e is shown in a sectional view to illustrate the interior of the vessel 105a-e. Further, cutaway lines 110 are used to indicate that commercial versions of the vessels 105a-e are generally substantially elongated from the shape shown in FIG. 1, and the middle sections are shown cutaway to better illustrate both gas and liquid plumbing features attached to the tops and bottoms, respectively, of the vessels 105a-e. Although pressure vessels of the present invention can be scaled to almost any size, a typical total volume of the CNG pressure vessels 105a-e is between 500 and 1000 litres.

Below the vessels 105a-e, a liquid plumbing portion of the system 100 includes a main liquid transfer line 115 that enables liquid, such as a water and antifreeze mixture, to be transferred between a liquid storage tank (not shown) and each of the CNG pressure vessels 105a-e. The main liquid transfer line 115 then branches into vessel-specific liquid lines 120a, 120b, 120c, 120d, 120e. Each vessel-specific liquid line 120a-e passes through a corresponding liquid transfer opening 125a, 125b, 125c, 125d, 125e, enabling liquid to be delivered directly into a bottom end the vessels 105a-e, respectively.

A liquid balance line 130 extends a balance liquid transfer path from an inside to an outside of each vessel 105a-e, and inter-connects all of the liquid transfer openings 125a-e. The liquid balance line 130 thus functions as a static liquid header, enabling relatively small amounts of liquid to move freely between the vessels 105a-e in order to balance pressures and liquid levels in the vessels 105a-e. “Pipe in pipe” fittings 135a, 135b, 135c, 135d, 135e enable the vessel-specific liquid lines 120a-e to pass through the balance liquid transfer path, such that in each liquid transfer opening 125a-e the balance liquid transfer path is defined by an annular space around each vessel-specific liquid line 120a-e.

Above the vessels 105a-e, a gas plumbing portion of the system 100 includes a main gas transfer line 140. For example, the line 140 can be used for supplying CNG to dispenser nozzles that attach to the fuel tanks of CNG vehicles. The main gas transfer line 140 branches into vessel-specific gas lines 145a, 145b, 450c, 145d, 145e. Each vessel-specific gas line 145a-e passes through a corresponding gas transfer opening 150a, 150b, 150c, 150d, 150e, enabling gas to be delivered directly into a top end the vessels 105a-e, respectively.

A gas balance line 155 extends a balance gas transfer path from an inside to an outside of each vessel 105a-e, and inter-connects all of the gas transfer openings 150a-e. The gas balance line 155 thus functions as a static gas header, enabling relatively small amounts of gas to move freely between the vessels 105a-e in order to further balance pressures and liquid levels in the vessels 105a-e. “Pipe in pipe” fittings 160a, 160b, 160c, 160d, 160e enable the vessel-specific gas lines 145a-e to pass through the balance gas transfer path, such that in each gas transfer opening 150a-e the balance gas transfer path is defined by an annular space around each vessel-specific gas line 145a-e.

As gas exits the top of the vessels 105a-e through the vessel-specific gas lines 145a-e, such as when the vessels 105a-e function as a CNG supply system for re-fuelling CNG vehicles, liquid is simultaneously pumped into the bottom of the vessels 105a-e through the vessel-specific liquid lines 125a-e. That enables a gas pressure in the vessels 105a-e to remain nearly constant, as volumes of CNG transferred from the vessels 105a-e are replaced in real time by equal volumes of liquid.

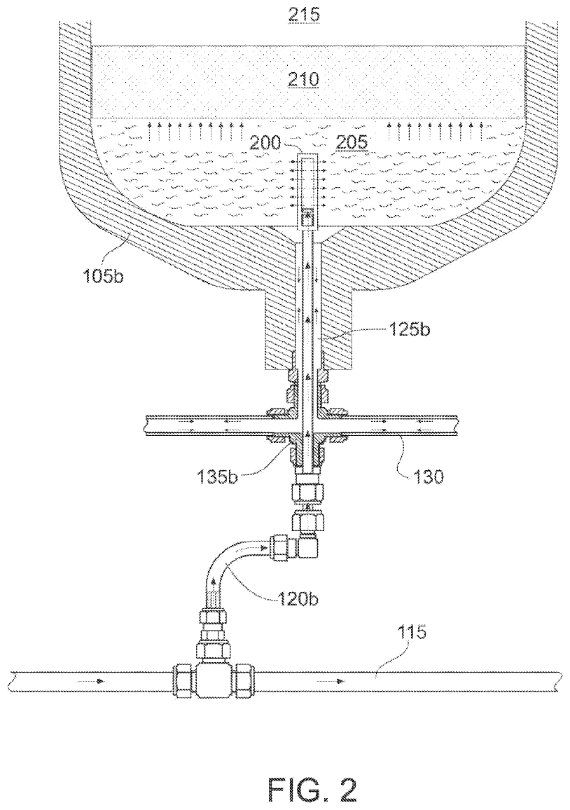

FIG. 2 is a diagram illustrating a close up view of the liquid plumbing at the bottom portion of the CNG pressure vessel 105b. A similar liquid plumbing arrangement is provided at each of the other pressure vessels 105a, 105c-e. The vessel-specific liquid line 120b extends through the “pipe in pipe” fitting 135b, shown here in a sectional view, and through the liquid transfer opening 125b. A distal end of the vessel-specific liquid line 120b is connected to a diffuser 200 comprising, for example, a mesh screen. As shown by the arrows extending from the diffuser 200, the diffuser 200 enables liquid to flow smoothly and in all directions out of the distal end of the line 120b. That reduces currents and turbulence in a liquid volume 205 located at the bottom of the vessel 105b when liquid is pumped into the vessel 105b. Further, the diffuser 200 enables uniform and even flow of liquid into the line 120b when liquid is forced out of the vessel 105b.

Floating on top of the liquid volume 205 is an oil layer 210 that is used to isolate a gas volume 215 positioned above the oil layer 210. As shown by the arrows, when liquid is pumped through the main liquid line 115 into the vessel-specific liquid line 120b, it is then forced through the diffuser 200 and displaces the gas volume 215. By reducing turbulence in the liquid volume during gas transfer, a lesser quantity of oil can be used to isolate the liquid from the gas and more reliable liquid level measurements are enabled.

However, if there are any pressure or liquid level imbalances between the vessel 105b and the other vessels 105a, 105c-d, as liquid is pumped either into or out of the diffuser 200, liquid can travel simultaneously either into or out of the vessel 105b through the portion of the balance liquid transfer path defined by the annular space around the vessel-specific line 120b in the liquid transfer opening 125b.

As will be understood by those having ordinary skill in the art, during a liquid transfer process between the main liquid line 115 and the vessels 105a-e, a liquid flow rate through each vessel-specific liquid line 125a-e may be significantly different from a liquid flow rate through each other vessel-specific liquid line 125a-e. That is due to factors such as liquid pump pressure pulses and non-uniform flow losses between the vessel-specific liquid lines 125a-e, which cause imbalances in the liquid flow rates in the lines 125a-e. But any such imbalances are immediately compensated for and corrected in real time by relatively minor balancing flows through the liquid balance line 130. Such balancing flows in the liquid balance line 130 are generally sufficiently low that the liquid in the liquid balance line 130 essentially provides a static liquid header between all of the vessels 105a-e.

Oil in the vessels 105b creates an oil layer 210 that floats on top of the liquid volume 205. Because the oil is both immiscible with the aqueous liquid in the liquid volume 205 and is less dense than the aqueous liquid, the oil layer 210 functions as a “liquid piston” that moves up and down inside the vessel 105b as the level of the liquid volume 205 changes.

The oil layer 210 creates a barrier that prevents the aqueous liquid from contacting and evaporating into the natural gas in the gas volume 215. In some cases the oil layer 210 may become saturated with natural gas. However, because the oil does not leave the vessel 105b, and because only a relatively thin oil layer 210 is required, relatively little natural gas is not available or is lost from storage.

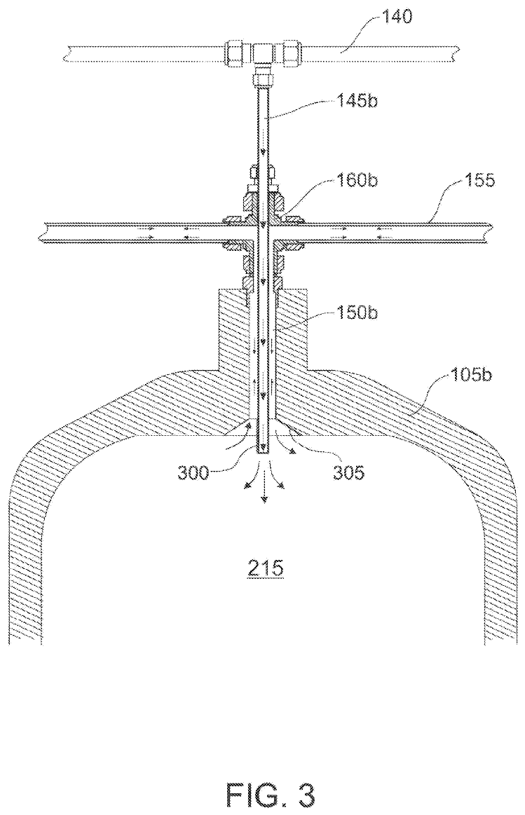

FIG. 3 is a diagram illustrating a close up view of the gas plumbing at the top portion of the CNG pressure vessel 105b. A similar gas plumbing arrangement is provided at each of the other pressure vessels 105a, 105c-e. As shown, the vessel-specific gas line 145b extends through the “pipe in pipe” fitting 160b and through the gas transfer opening 150b. A distal end 300 of the vessel-specific liquid line 145b opens into the gas volume 215 at the top of the vessel 105b. An inner end 305 of the balance gas transfer path in the gas transfer opening 150b comprises an annular opening into the gas volume 215 that enables gas to flow into or out of the vessel 105b to maintain the vessels 105a-e at an equal pressure.

As will be understood by those having ordinary skill in the art, during a gas transfer process between the main gas line 140 and the vessels 105a-e, a gas flow rate through each vessel-specific gas line 145a-e will be approximately equal to a gas flow rate through each other vessel-specific gas line 145a-e. Nevertheless, due to factors such as uneven gas flow losses between the vessel-specific gas lines 125a-e, imbalances in the gas flow rates 125a-e may occur. But any such imbalances are immediately compensated for and corrected in real time by minor balancing flows through the gas balance line 155. Such balancing flows in the gas balance line 155 are generally of a magnitude that the gas in the gas balance line 155 essentially provides a static gas header between all of the vessels 105a-e.

Referring again to FIG. 1, at a liquid line end 170, the liquid balance line 130 can be connected to a differential pressure (DP) cell (not shown). Similarly, at a gas line end 175, the gas balance line 155 also can be connected to a DP cell. The DP cells can thus obtain an accurate measurement of the pressure values that are common to all of the vessels 105a-e, and thus accurately determine the liquid level in the vessels 105a-e. Thus, according to some embodiments of the present invention, a static liquid header and a static gas header function together to maintain a constant pressure and even liquid levels across a plurality of CNG storage vessels. Embodiments of the invention enable accurate, real time measurement of liquid levels inside a plurality of CNG vessels at high pressure while liquid is pumped into the vessels to displace or compress gas, or while gas is pumped into the vessels forcing liquid out of the vessels.

A static liquid header enables liquid to flow between vessels, which balances any differences in liquid levels across the plurality of vessels caused by, for example, pump pressure pulses and unequal flow losses.

Further, according to some embodiments, a static gas header enables gas to flow between vessels, further allowing gas pressures and liquid levels inside the vessels to equalise. Because gas pressures and liquid levels are balanced and equal across a plurality of vessels in a system, significantly greater volumes (for example, greater than 90%) of the volumes of the vessels can be used as working volumes. That enhances the overall efficiency and effectiveness of the gas storage system.

The above description of various embodiments of the present invention is provided for purposes of description to one of ordinary skill in the related art. It is not intended to be exhaustive or to limit the invention to a single disclosed embodiment. As mentioned above, numerous alternatives and variations to the present invention will be apparent to those skilled in the art of the above teaching. Accordingly, while some alternative embodiments have been discussed specifically, other embodiments will be apparent or relatively easily developed by those of ordinary skill in the art. Accordingly, this patent specification is intended to embrace all alternatives, modifications and variations of the present invention that have been discussed herein, and other embodiments that fall within the spirit and scope of the above described invention.

1. A pressure vessel balanced refuelling system, comprising:
a plurality of pressure vessels, each vessel having a liquid transfer opening for the entry and exit of a liquid that is used to displace a gas inside each vessel;
a liquid transfer line extending from an outside to an inside of each vessel in the plurality of pressure vessels through the liquid transfer opening of each vessel;
a liquid balance line inter-connecting the liquid transfer opening of each vessel with the liquid transfer opening of each other vessel;
wherein for each vessel the liquid transfer line and the liquid balance line are different lines, and a balance liquid transfer path extends from an inside to an outside of one vessel, then from the outside to the inside of each other vessel through the liquid balance line, enabling a liquid level in the one vessel to remain approximately equal to a liquid level in each other vessel;
a gas transfer opening in each vessel for the entry and exit of the gas;
a gas transfer line extending from an outside to an inside of each vessel in the plurality of pressure vessels through the gas transfer opening of each vessel; and
a gas balance line extending from an outside to an inside of each vessel in the plurality of pressure vessels and inter-connecting the gas transfer opening of each vessel with the gas transfer opening of each other vessel;
wherein for each vessel the gas transfer line and the gas balance line are different lines, and a balance gas transfer path extends from an inside to an outside of one vessel then from the outside to the inside of each other vessel through the gas balance line, enabling a gas pressure in the one vessel to remain equal to a gas pressure in each other vessel.

2. The pressure vessel balanced refuelling system of claim 1, wherein each vessel contains a liquid diffuser at a distal end of the liquid transfer line.

3. The pressure vessel balanced refuelling system of claim 1, wherein the liquid transfer line extends through the liquid transfer opening of each vessel in a “pipe in pipe” arrangement.

4. The pressure vessel balanced refuelling system of claim 1, wherein the system further comprises both the liquid and the gas inside each vessel and an oil layer floating on top of the liquid.

5. The pressure vessel balanced refuelling system of claim 1, wherein the liquid transfer line branches from a main line to a plurality of vessel-specific liquid lines, wherein one vessel-specific liquid line extends into each vessel in the plurality of vessels.

6. The pressure vessel balanced refuelling system of claim 5, wherein during a liquid transfer process, a liquid flow rate through each vessel-specific liquid line is different than a liquid flow rate through each other vessel-specific liquid line.

7. The pressure vessel balanced refuelling system of claim 1, wherein during a liquid transfer process, the liquid flows through the liquid balance line to eliminate liquid level imbalances between the plurality of pressure vessels.

8. The pressure vessel balanced refuelling system of claim 1, wherein, the gas transfer line extends through the gas transfer opening of each vessel in a “pipe in pipe” arrangement.

9. The pressure vessel balanced refuelling system of claim 1, wherein the gas transfer line branches from a main line to a plurality of vessel-specific gas lines, wherein one vessel-specific gas line extends into each vessel in the plurality of vessels.

10. The pressure vessel balanced refuelling system of claim 1, wherein during a gas transfer process, a gas flow rate through each vessel-specific gas line is approximately equal to a gas flow rate through each other vessel-specific gas line.

11. The pressure vessel balanced refuelling system of claim 1, wherein during a gas transfer process, the gas flows through the gas balance line to eliminate pressure imbalances between the plurality of pressure vessels.

12. The pressure vessel balanced refuelling system of claim 1, wherein the refuelling system is a stationary system for CNG storage and delivery.

13. The pressure vessel balanced refuelling system of claim 1, wherein a pressure measurement instrument is attached to the liquid balance line.

14. The pressure vessel balanced refuelling system of claim 1, wherein a pressure measurement instrument is attached to the gas balance line.
